(19) United States
(12) Patent Application Publication
(10) Pub. No.: US 2026/0342171 A1
(43) Pub. Date: Oct. 29, 2026

(54) ELECTROMECHANICAL ACTUATOR, MOTORIZED DRIVE DEVICE AND CONCEALMENT DEVICE COMPRISING SUCH AN ACTUATOR

(71) Applicant: SOMFY ACTIVITES SA, CLUSES (FR)

(72) Inventors: Sylvain DECONCHE, CLUSES (FR); Quentin LEPINE, CLUSES (FR); Sébastien LEMAITRE, CLUSES (FR); Anny-Laure PETRIS, CLUSES (FR)

(21) Appl. No.: 19/549,918

(22) Filed: Feb. 25, 2026

(30) Foreign Application Priority Data
Feb. 28, 2025 (FR) 2502041

(51) Int. Cl. H02K 5/24; H02K 7/06; H02K 11/30

(52) U.S. Cl. CPC H02K 5/24; H02K 7/06; H02K 11/30; H02K 2207/03; H02K 2211/03; H02K 2213/03

(57) ABSTRACT

The present invention relates to an electromechanical actuator of a concealment device, the actuator comprising at least one electric motor, a casing, an electronic control board (142) and a mechanical vibrations-filtering member (50). The electric motor, the electronic control board (142) and the filtering member (50) are mounted inside the housing, in the assembled configuration of the electromechanical actuator. The mechanical filtering member (50) comprises a first part (52) forming a mechanical filter and a second part defining a volume (V54) for receiving the electronic board (142). Furthermore, the mechanical filtering member (50) is monobloc.

The present invention relates to an electromechanical actuator of a concealment device, as well as to a motorized drive device for driving a screen of a concealment device, comprising, among other things, such an electromechanical actuator. The present invention also relates to a concealment device comprising, among other things, such a motorized drive device.

The technical field of the present invention is that of concealment devices which comprise a motorized drive device driving a screen between a first position and at least a second position.

In this type of device, it is known to use an electromechanical actuator to drive a winding shaft on which the screen is fixed.

Such a screen may be, for example, a blind, a roller shutter or a grille.

The concealment device is connected to a frame by a fastening device. The frame may be a wall, for example, made of concrete, wood, plaster or brick. The concealment device may be mounted on the frame by means of a metal bracket.

An electromechanical actuator comprises an electric motor which, during operation, creates vibrations. These vibrations may be transmitted to the components linked to the electric motor, notably a tubular casing of the electromechanical actuator, an electromechanical actuator head and/or the winding tube, which generates noise when a concealment device incorporating such an actuator is used. These vibrations can be transmitted mechanically as far as the frame and the generated noise is amplified. The preferred vibration transfer path is the actuator head.

This issue is addressed in WO2018/104488A1 which provides for inserting an electric motor suspension module inside a tubular casing of an electromechanical actuator. This suspension member comprises several annular plates arranged perpendicularly to a longitudinal actuator and juxtaposed along this axis. This solution is robust and presents good repeatability, while being simple to implement. However, this solution increases the overall length of the actuator and requires a complex injection mold to manufacture the suspension module.

Moreover, WO2020/025711A1 discloses a mechanical vibrations-filtering module for an electromechanical actuator which comprises two end portions having a larger diameter than a central portion. The mechanical vibrations-filtering module can be easily adapted to its conditions of use by adjusting the diameter of the end portions and/or the length of the central portion.

WO2020/064882A1 presents another solution, in which the filtering module comprises rings respectively fixed to a casing and to a shaft of a head of the actuator. This solution is relatively compact and is based on a ball joint function of a connection between different parts of the filtering module, using the vibration attenuation properties of an elastomer material. These properties can vary over time, which may lead to a degradation of filtering performance as the filtering module ages.

CN208226759U shows the use of an absorbing element inserted between the actuator casing and a geared motor. CN215897475U discloses the use of a structure intended to reduce vibrations, and which comprises several damping members. In general, the use of filtering elements within an actuator is also known from WO2005/090736A1.

These known materials are generally satisfactory. However, incorporating a vibration-decoupling member within an electromechanical actuator tends to increase its axial length, which can cause problems in size. In addition to length issues, incorporating a vibration decoupling member requires specific assembly steps. This assembly therefore requires fastening interfaces to be provided between certain parts. These interfaces do not contribute to the objective of vibration reduction; on the contrary, and moreover they increase the length of the electromechanical actuator. These interfaces are sometimes subject to design or factory-assembly quality defects and can negatively contribute to the objective of vibration reduction. On the other hand, the filtering elements must be adapted to each specific electromechanical actuator design to be effective.

It is, in particular, these drawbacks that the invention aims to remedy by proposing a new electromechanical actuator that comprises a vibrations-filtering member and that is compact and adapted to the specific design of the electromechanical actuator, in order to maintain a high level of performance for mechanical vibrations-filtering and force-transmission.

To this end, the invention relates to an electromechanical actuator of a concealment device, this actuator comprising at least one electric motor, a casing, an electronic control board and a mechanical vibrations-filtering member, the electric motor, the electronic control board and the filtering member being mounted inside the casing, in an assembled configuration of the electromechanical actuator. In accordance with the invention, the mechanical filtering member comprises a first part forming a mechanical filter and a second part defining a volume for receiving the electronic board, and in that the mechanical filtering member is monobloc.

By means of the invention, the mechanical filtering member can establish the connection between the actuator head and its casing, while effectively supporting the electronic control board by means of its second part, without substantially increasing the length of the actuator relative to an actuator comprising an electronic control board and lacking a mechanical filtering member. The present invention allows to integrate the mechanical filtering function directly between an actuator head and the support for the electronic board. Since the mechanical filtering member is monobloc, it is not necessary to provide assembly means between, on the one hand, a filtering member and, on the other hand, a support for the electronic board. This allows to gain axial compactness for the electromechanical actuator.

According to advantageous but not mandatory aspects of the invention, such an electromechanical actuator may incorporate one or more of the following features, taken in any technically permissible combination:
The first part of the mechanical filtering member is integral with a head of the electromechanical actuator and arranged, along a longitudinal axis of the mechanical filtering member, between the actuator head and the second part.
The first part of the mechanical filtering member is annular, whereas the second part of the mechanical filtering member is generally in the shape of a half-cylinder.
One end of the first part of the mechanical filtering member and one end of the second part of the mechanical filtering member are common and form a ring.
The first part is provided with slots and hinges arranged at the ends of the slots.
The slots each extend according to a circumferential direction around a longitudinal axis of the mechanical filtering member.
Two slots and two hinges are provided in the same plane, orthogonal to a longitudinal axis of the mechanical filtering member.
Slots and hinges are provided in at least two planes orthogonal to a longitudinal axis of the mechanical filtering member, and the slots and hinges provided in a first plane orthogonal to the longitudinal axis are angularly offset, preferably by 90°, relative to the slots and hinges provided in a second plane orthogonal to the longitudinal axis.
Damping bushings are mounted around the mechanical filtering member and interposed between this member and an internal radial surface of the casing, at the two longitudinal ends of this member.

According to a second aspect, the invention relates to a motorized drive device for driving a screen of a concealment device between at least a first position and at least a second position, comprising a winding tube of the screen and an actuator, such as described above, engaged in the winding tube and supported, relative to a supporting structure, by means of an actuator head engaged at least partially in the first part of the mechanical filtering member of the actuator.

According to a third aspect, the invention relates to a concealment device comprising a screen movable between at least one first position and at least one second position and a motorized drive device for the screen between its first and second positions, that is, as described above.

The invention will be better understood, and other advantages thereof will appear more clearly on reading the following description of an embodiment of an electromechanical actuator, a motorized drive device and a concealment device in accordance with its principle, given solely by way of example and with reference to the appended drawings in which:

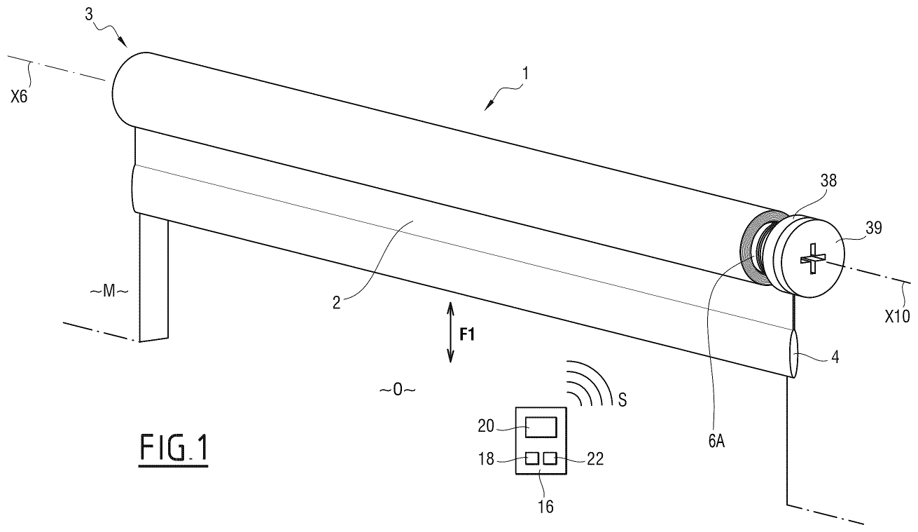

FIG. 1 is a partial perspective view of a concealment device in accordance with the invention, incorporating an electromechanical actuator and a drive device also in accordance with the invention;

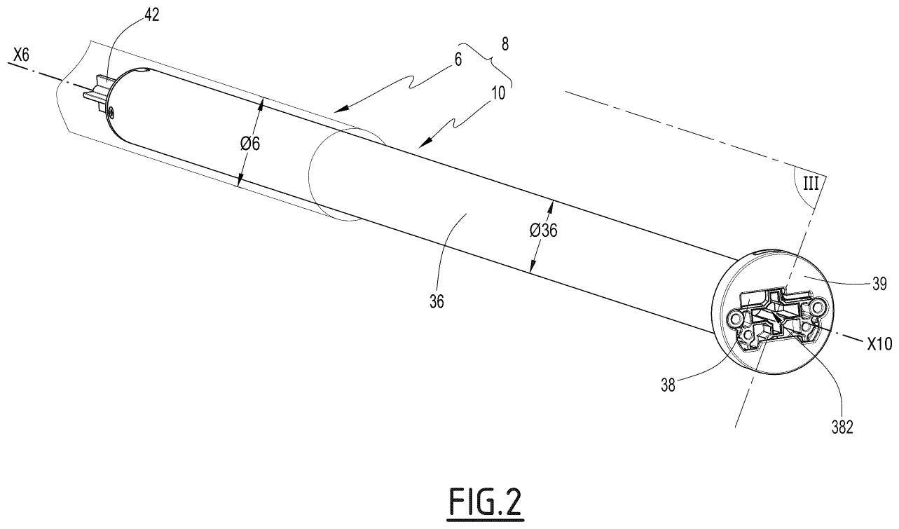

FIG. 2 is a perspective view of the actuator and a winding tube of the concealment device of FIG. 1, which together form a motorized drive device in accordance with the invention;

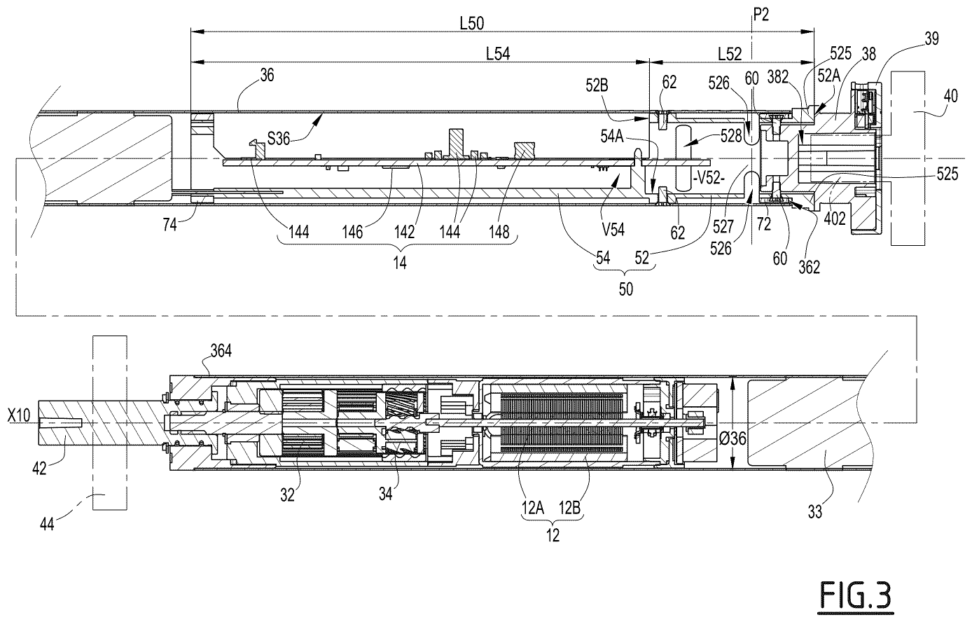

FIG. 3 is a longitudinal section of the actuator of FIG. 2, according to plane III in that figure;

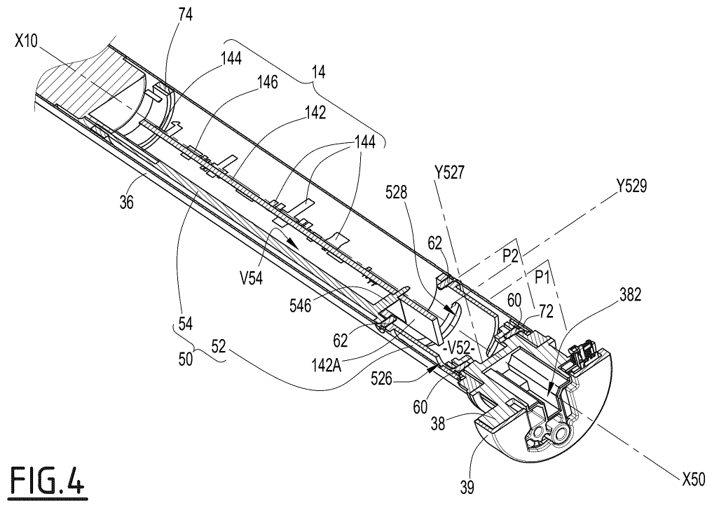

FIG. 4 is a perspective section corresponding to the upper part of FIG. 3;

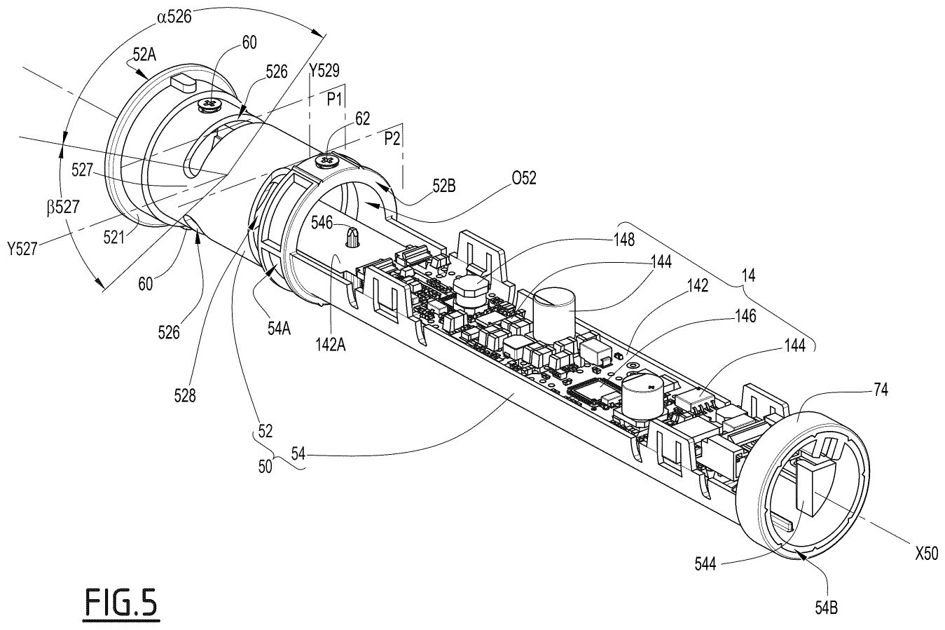

FIG. 5 is a perspective view of a mechanical filtering member, an electronic control board and various accessories belonging to the electromechanical actuator of FIGS. 2 to 4;

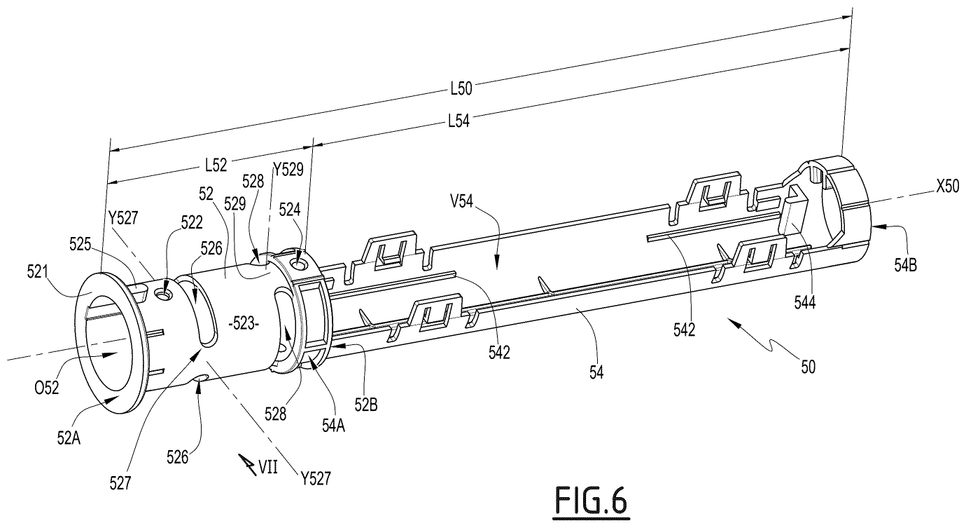

FIG. 6 is a perspective view of the mechanical filtering member alone; and

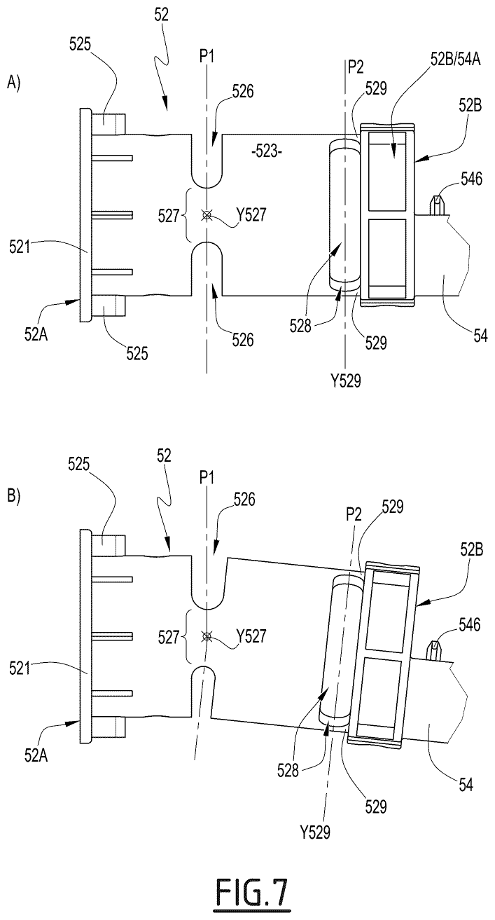

FIG. 7 represents, on two inserts A) and B), a part of the mechanical filtering member of FIG. 6 in two distinct operating configurations.

First, with reference to FIG. 1, an installation 1 is described comprising a closing, concealment or solar-protection device 3 in accordance with a first embodiment of the invention. This installation 1 is implemented in a building represented by one of its walls M which includes an opening O in which a window or a door, not represented, is arranged. This installation 1 is equipped with a screen 2 belonging to the closing, concealment or solar-protection device 3, which constitutes, for example, a motorized blind.

The screen 2 is configured to conceal, at least partially, the opening O provided in the wall M, by being in positions selected by a user, between an upper end-of-travel position and a lower end-of-travel position.

The closing, concealment or solar-protection device 3 is hereinafter referred to as “concealment device” and comprises the screen 2. The expression “concealment device” therefore also covers closing or solar-protection devices.

Here, the screen 2 may be formed by a fabric, woven or not, and comprises a load bar 4 which ensures tension to a part of the unrolled screen 2 relative to a winding tube 6, movable in rotation about a winding axis X6 which is horizontal in the mounted configuration of the installation 1.

Depending on the rotation of the winding tube 6 about winding axis X6, a more or less large part of the screen 2 is unrolled and hangs below the winding tube 6 and the load bar 4 is displaced vertically, in the direction of the double arrow F1 in FIG. 1.

An electromechanical actuator 10 is arranged in the winding tube 6.

The winding tube 6 is represented in a transparent and partial manner, axially offset toward the left, in FIG. 2, to allow complete visualization of the electromechanical actuator 10.

The electromechanical actuator 10 comprises an electric motor 12. Advantageously, the electric motor 12 comprises a rotor 12A and a stator 12B, which are positioned coaxially about an axis of rotation X10 of the electromechanical actuator 10.

The axes X6 and X10 are merged in the mounted configuration of the concealment device 3 within the installation 1.

Advantageously, the electric motor 12 is of the brushless electronically commutated type, also called “BLDC” or “permanent-magnet synchronous”. Alternatively, the electric motor 12 may be DC or asynchronous, supplied by alternating current.

The electromechanical actuator 10 also comprises an electronic control unit 14 configured to control the electric motor 12 from control commands received from a control unit 16,which may be a local or central, fixed or mobile control unit. Preferably, the electronic control unit 14 comprises an electronic control board 142 fitted with electronic components 144, of which a microprocessor 146.

The electronic board 142 may also be referred to as a printed circuit board or PCB.

Advantageously, the control unit 16 is equipped with at least one selection element 18 and at least one display element 20. The control unit 16 also comprises a first remote communication module 22 able to transmit, and possibly receive, electromagnetic signals S, in particular radio signals, destined for the electronic control unit 14 or coming from it.

In this regard, the electronic control unit 14 is equipped with a second communication module 148 able to receive electromagnetic signals S, in particular radio signals, and possibly transmit feedback signals to the control unit 16, in the case of bidirectional communication between the electronic control unit 14 and the control unit 16.

The second communication module 148 is one of the electronic components 144 of the electronic control unit 14.

Advantageously, to be able to communicate effectively with the communication module 22, the communication module 24 is connected to an antenna, not represented, which extends partly within the winding tube 6 and partly outside the winding tube.

The electromechanical actuator 10 also comprises a reducer 32, an energy source, such as a set of batteries 33, and a brake 34. The energy source is represented by its outer envelope in FIG. 3.

The reducer 32 comprises at least one reduction stage, for example, of the epicyclic type, or of another type. The brake 34 allows to control the speed of rotation of the winding tube 6 about the winding axis X6 or to block rotation of this tube.

Here, the set of batteries 33 is positioned, along the axis X10, between the electric motor 12 and the electronic control unit 14. In one alternative embodiment, not represented, of the invention, the set of batteries 33 may be positioned, along the axis X10, between the electric motor 12 and the brake 34. According to another alternative, not represented, the set of batteries 33 is positioned, along the axis X10, opposite the electric motor 12 relative to the electronic control unit 14.

Here, the brake 34 is positioned, along the axis X10, between the electric motor 12 and the reducer 32. In one alternative embodiment, not represented, of the invention, the reducer 32 may be positioned, along the axis X10, between the electric motor 12 and the brake 34. According to another alternative, not represented, the brake is positioned, along the axis X10, between two stages of the reducer 32.

The actuator 10 also comprises a casing 36 in which the elements 12,14, 32, 33 and 34 are arranged and which extends, between a first axial end 362 and a second axial end 364 opposite the first axial end, along the axis X10. The axial end 362 of the casing 36 is oriented on the same side as one axial end 6A of the winding tube 6 visible in FIG. 1.

The antenna, not represented, also extends partly outside the casing 36.

The casing 36 is cylindrical shaped, preferably with a circular cross-section. It may be realized in metal or plastic material. The external diameter Φ36 of the casing 36 is strictly less than the internal diameter Φ6 of the winding tube. The electromechanical actuator is said to be tubular in that the external diameter Φ36 of its casing 36 is much smaller than its axial length, taken along the axis X10.

In the example of the figures, the external diameter Φ36 is 25 mm. This provides good radial compactness for the electromagnetic actuator 10, compatible with the winding tubes 6 having a relatively small internal diameter Φ6, notably equal to 28 mm. However, the solution is also applicable to other external diameters of tubular electromechanical actuators.

Alternatively, the solution is also applicable to a non-tubular actuator the casing of which presents a diameter of the same order of magnitude as its axial length, or to an actuator the casing of which presents polygonal cross-section.

A crown bearing, not represented, is arranged around the end 362 of the casing 36 and inside the end 6A of the winding tube 6 which it supports, allowing the winding tube 6 to rotate about the axis X10 relative to the casing 36.

An actuator head 38 also belongs to the actuator 10 and allows it to be held in position inside the winding shaft 6. The actuator head 38 is engaged in the casing 36, on the side of its first end 362.

The actuator head 38 allows, notably, to assemble the actuator 10 on a support 40 which may be mounted on the wall M or on an end plate of a box, not represented, surrounding the winding tube 6 or on a support bracket, not represented, itself mounted on the wall or suspended from a ceiling. For this purpose, the actuator head 38 is provided with a housing 382 configured to receive one or more centering pins 402 carried by the support 40. The actuator head 38 therefore ensures, notably, a mechanical support and force-taking function for the electromechanical actuator 10. In addition, the actuator head 38 and the support 40 together constitute a reference point for the electric motor 12.

For clarity of the drawing, the support 40 and its pin 402 are only represented in FIG. 3, in chain dotted lines.

A cover 39, which is part of the electromechanical actuator 10, is attached, preferably removably, to the actuator head 38, on the side of this head opposite the casing 36.

An output shaft 42 of the electromechanical actuator 10 projects from the casing 36, opposite the actuator head 38, in other words, on the side of the second end 364 of this casing. The output shaft is configured to be driven in rotation by the electric motor 12 about the axis of rotation X10 through the brake 34 and the reducer 32.

This output shaft 42 is equipped with a coupling wheel 44 integral in rotation, around the winding axis X6, of the winding tube 6. For clarity of the drawing, the coupling wheel 44 is represented only in FIG. 3, in center lines.

Rotation of the output shaft 42 around the axis of rotation X10, resulting from the operation of the electric motor 12, causes the winding tube 6 to rotate around the winding axis X6 by means of the coupling wheel 44, in one of two opposite directions of rotation, and to unwind or wind the screen 2 around the winding tube 6, by displacing the load bar 4 in one of the directions represented by the double arrow F1 in FIG. 1.

Thus, the winding tube 6 and the electromechanical actuator 10 belong to a motorized drive device 8, which allows to selectively displace the screen 2 between positions chosen by the user of the concealment device 3.

When the electromechanical actuator 10 drives its output shaft 42 in rotation about the axis of rotation X10, vibrations are generated. These vibrations are notably due to operation of the electric motor 12, to the contact forces of the gears of the reducer 32 and/or to discontinuous friction of the brake 34.

A mechanical filtering member 50 is mounted inside the casing 36 and has the function of filtering, in other words attenuating and/or damping, or even eliminating, the above-mentioned vibrations, in order that they propagate as little as possible outside the casing 36.

The mechanical filtering member 50 is realized of a material that is elastically deformable under normal conditions of use of the electromechanical actuator 10. By way of example, the material constituting the mechanical filtering member 50 may be polyoxymethylene(POM), notably, a POM-H homopolymer also called Delrin.

X50 denotes a longitudinal axis of the mechanical filtering member 50. In the mounted configuration of the electromechanical actuator 10, the axes X10 and X50 are merged.

The mechanical filtering member 50 comprises a first part 52 and a second part 54 which are realized in one piece. In other words, the parts 52 and 54 of the mechanical filtering member 50 are monobloc with each other, which contributes to the axial compactness of the actuator, in other words, its compactness along the axis of rotation X10.

The first part 52 is closest to the actuator head 38 in the mounted configuration of the electromechanical actuator 10 and may, as such, be qualified as a proximal part. Conversely, the second part 54 is farthest from the actuator head 38 in the mounted configuration of the electromechanical actuator 10 and may, as such, be qualified as a distal part.

The first part 52 is tubular and extends circumferentially around the longitudinal axis X50 through 360°. On the other hand, the second part 54 is substantially in the shape of a half-cylinder, in particular with a semicircular generatrix. It defines a volume V54 for at least the partial reception of the electronic board 144 and its components 144.

52A denotes a first end of the first part 52 opposite the second part 54. The first end 52A is, in practice, formed by an annular flange 521 surrounding a circular orifice O52 for introducing part of the actuator head 38 into the first part 52.

52B denotes a second end of the first part 52, which is opposite the first end 52A. The second end 52B surrounds a circular orifice O′52 providing access to an internal volume V52 of the first part 52, opposite the circular orifice O52.

The second end 52B is visible in FIG. 5, whereas the first end 52A is visible in FIG. 6.

Advantageously, the second end 52B of the first part 52 also forms a first end 54A of the second part 54. In other words, the two parts 52 and 54 are common at the second end 52B and the first end 54A which form a ring supporting, on either side, the cylinder of the first part 52 and the half-cylinder of the second part 54. The second end 52B thus ensures holding of the second part 54 and ensures contact with the casing 36, by its outer surface which may, for example, be provided with knurls. The first part 52 is provided with two orifices diametrically opposite relative to the longitudinal axis X50, only one of which is visible in FIG. 6 with the reference 522. Each of orifices 522 and its counterpart receives a screw 60 for fixing the first part 52 to the actuator head 38.

Thus, the mechanical filtering member 50, more particularly its first part 52, can be mounted and immobilized on the actuator head 38 by means of the screws 60.

On the other hand, the part 52 is provided with two other orifices diametrically opposite relative to the longitudinal axis X50, only one of which is visible in FIG. 6 with the reference 524. Each orifice 524 receives a screw 62 for fixing the casing 36 to the part 52.

Thus, the mechanical filtering member 50, more particularly its first part 52, can be mounted and immobilized on the casing 36 by means of the screws 62. The mechanical filtering member 50 is in contact with the casing 36 in a contact zone materialized by the second end 52B of the first part 52 and by the screws 62 and thus has a degree of freedom around this contact zone. This situation allows torsional forces to be applied to the first part 52.

The orifices 522 and their counterpart are provided near the first end 52A, whereas the orifices 524 and their counterpart are formed near the second end 52B.

In FIG. 5, the screws 60 and 62 are shown in position in the orifices 522 and 524, whereas the casing 36 and the actuator head 38 are not represented.

The mechanical filtering member 50 is also provided, near its first end 52A. with two heels 525, diametrically opposite, and intended to be engaged in notches, not represented, of the casing 36, which allows to ensure locking in rotation of the casing 36 on the mechanical filtering member 50, before fitting the fixing screws 62.

The heels 525 constitute torque take-up notches between the mechanical filtering member 50 and the casing 36 and allow to avoid angular drift of these elements relative to each other. Indeed, there is a functional clearance between the heels 525 and the casing 36 in order to ensure take-up of the torsional torque exerted within the first part 52. This functional clearance is necessary for proper operation of the mechanical filter constituted by the first part 52 but must not lead to angular drift of these parts over time.

The first part 52 of the filtering member 50 forms a mechanical vibrations-filter forming a connecting member between the casing 36 and the actuator head 38, which allows it to act to damp vibrations liable to propagate between the casing 36 and the actuator head 38.

L52 denotes the length of the first part 52 of the mechanical filtering member 50. L54 denotes the length of the second part 54 of the filtering member 50. L50 denotes the total length of the mechanical filtering member 50. The lengths L50, L52 and L54 are measured parallel to the longitudinal axis X50. On the other hand, the length L50 is equal to the sum of the lengths L52 and L54. In other words, the following relation applies:

L50=L52+L54.

The length L52 is measured between the ends 52A and 52B.

The length L52 represents only a relatively small part of the length L50. In other words, the part of the mechanical filtering member 50 that serves to filter or damp vibrations between the elements 36 and 38 has a length L52 that is relatively small relative to the total length L50 of the mechanical filtering member 50 which is monobloc.

In practice, the length 54 is determined so as to be able to accommodate the electronic board 142, this board being defined relative to the need of the electronic components and the selected layout of these components on the electronic board 142. The length L52 is determined as a function of the forces to be supported between the casing 36 and the actuator head 38. This length L52 is also determined by taking into account the lowest desired filtering frequency. This length L52 can therefore be adapted depending on the exact configuration of the electromechanical actuator 10, notably its constituent elements 12, 32 to 34, 42 and 44 and the need for vibrations attenuation.

523 denotes an annular cylindrical wall of the first part 52 which surrounds the longitudinal axis X50 and the internal volume V52 of the first part 52.

The wall 523 is pierced with two slots 526 which are provided in a same plane P1 perpendicular to the axis X100. The two slots 526 each extend according to a circumferential direction around the axis X50, over an angular amplitude α526 between 150° and 170°. Between the two slots 526, the wall 523 forms two hinges 527 able to deform, as can be seen when comparing the inserts A) and B) of FIG. 7. Each hinge 527 extends, in plane P1, over an angular amplitude β527 between 20° and 60°.

Since the slots 526 are identical to each other, the hinges 527 are diametrically opposite relative to the longitudinal axis X50, which allows elastic deformation of these hinges about an axis Y527 radial to the longitudinal axis X50 and passing through the center of the two hinges 527. This deformation is visible when comparing the inserts A) and B) of FIG. 7.

In a plane P2 parallel to plane P1, the wall 523 is pierced with two other slots 528 which each extend according to a circumferential direction around the axis X50, over an angular amplitude equal to that of the slots 526. The slots 528 are identical and connected by the hinges 529 formed by the cylindrical wall 523 and which are able to deform, as with the hinges 527. The hinges 529 each extend over an angular amplitude equal to that of the hinges 527.

The hinges 529 are diametrically opposite and can deform elastically about a Y529 radial to longitudinal axis X50.

In practice, over 360° of circumference and in each of the planes P1 and P2, there is a succession of a first slot 526 or 528, a first hinge 527 or 529, a second slot 526 or 528 and a second hinge 527 or 529.

Advantageously, each of the planes P1 and P2 is orthogonal to the longitudinal axis X50.

The slots 528 are angularly offset, around the longitudinal axis X100, relative to the slots 526. In practice, the angular offset between the slots 526 and 528 is advantageously chosen equal to 90°.

Thus, the axes Y527 and Y529 are perpendicular.

As visible notably in FIGS. 5 and 7, the hinges 527 are aligned with the slots 528 according to a first direction parallel to the longitudinal axis X50, whereas the hinges 529 are aligned with the slots 526 according to a second direction parallel to the longitudinal axis X50.

The slots 526 and 528, on the one hand, and the hinges 527 and 529, on the other hand, allow the first part 52 of the mechanical filtering member 50 to deform, to dynamically cut off, in other words, filter the vibrations transmitted by the casing 36, by limiting their transmission toward the actuator head 38.

The axial offset, along the longitudinal axis X50, and the angular offset of the slots 526 and 528 around the longitudinal axis X50 allows to create an axial vibration-filter at the first part 52. Indeed, when the zone of the first part 52, closest to its second end 52B, tends to rotate around the longitudinal axis X50 relative to the flange 521, or to bend relative to this flange, the first part 52 can accompany this movement thanks to the elastic deformation of the hinges 527 and to the widening or narrowing of the edges of the slots 526 and/or 529, as shown in FIG. 7.

Thanks to the use of the mechanical filtering member 50, in particular of its first part 52, a vibrations decoupling is obtained within the electromechanical actuator 10 between the electric motor 12, rigidly connected to the casing, the actuator head 38, and the support 40.

The volume V54 defined by the second part 54 allows to accommodate the electronic board 142 without having to install in the casing 36 a support element distinct from the mechanical filtering member 50.

As represented in FIGS. 3 to 5, a part 142A of the electronic board 142 can enter inside the first part 52 into the internal volume V52, which allows to reduce the total length L50 of the mechanical filtering member 50, while keeping an electronic board 142 of sufficient dimensions to accommodate all the electronic components 144 necessary to its function.

To ensure that the electronic board 142 is held in position in the volume V54, the second part 54 of the mechanical filtering member 50 is equipped with internal ribs 542 and an axial stop 544. A centering pin 546 is advantageously provided to pass through the part 142A of the electronic board 142 engaged in the internal volume V52 of the first part 52. The centering pin 546 and the axial stop 544 allows to lock the electronic board 142 in rotation in the volume V54. The internal ribs 542 allow to position the electronic board 142 transversely to the longitudinal axis X50. Clipping members allow to retain the electronic board 142 in the opposite direction.

The second part 54 of the mechanical filtering member 50 does not deform during filtering of vibrations by the first part 52. This ensures the physical integrity of the electronic control unit 14, in particular by avoiding mechanical stresses on the electronic board 142 and the components 144.

A positioning bushing 72, preferably ring-shaped, is arranged radially between the first part 52 of the mechanical filtering member 50 and an internal radial surface S36 of the casing 36, at the orifices 522 and the screws 60 along the longitudinal axis X50. This bushing 72 is intended to deform in order to provide a degree of freedom between the casing 36 and the mechanical filtering member 50, in the vicinity of the junction zone between the actuator head 38 and the mechanical filtering member 50. The bushing 72 is visible only in FIGS. 3 and 4. For clarity of the drawing, it is not represented in FIG. 5.

On the other hand, a second positioning bushing 74, preferably ring-shaped, is mounted near to the second end 54B of the second part 54 opposite the first part 52. This second bushing 74 is inserted radially between the second end 54B and the internal radial surface S36 of the housing 36. This second bushing 74 also provides a degree of freedom for positioning the mechanical filtering member 50 inside the casing 36.

The two bushings are mounted around the mechanical filtering member 50 and interposed between this member and the internal radial surface S36 of the casing 36, at the two longitudinal ends of this member.

In practice, the two bushings 72 and 74 are realized of a material more flexible than that of the mechanical filtering member 50, for example elastomer or rubber or TPU.

These two bushings 72 and 74 allow two needs to be met: a first need for mobility, without which the mechanical filtering member 50 cannot bend and fulfill its role, and a second need for damping in these mobility zones, to avoid any risk of undamped contact.

The bushing 74 also allows to prevent torsional forces from being transmitted to the electronic board 142 and the bushing 72 contributes on its side to filtering airborne noise.

The two bushings 72 and 74 also allow to guide the mechanical filtering member 50 during its insertion inside the casing 36.

According to one aspect of the invention, not represented, connection elements, not represented, notably ribbons or power, data or antenna cables, may run inside the first part 52 of the mechanical filtering member 50, in order to connect a secondary electronic control unit located in the head to the electronic control unit 14 and/or to supply one and the other with current or signals. The part 142A and these connection elements must be mounted at a distance from the wall 523, the slots 526 and 528 and the hinges 527 and 529, so as not to interfere with the mechanical filter function of the first part 52. That is why the part 142A of the electronic board which penetrates the internal volume V52 of the first part 52 advantageously presents a reduced transverse dimension relative to the main part of this electronic board housed in the volume V54. Likewise, the cables or ribbons are dimensioned to be taut in the mounted configuration of the electromechanical actuator 10 and hence are not or are only slightly in contact with the first part 52 and do not interfere with the mechanical filter function.

Thanks to the use of the monobloc mechanical filtering member 50, it is possible to reduce the overall size of the actuator, notably its axial dimension, while ensuring, with the first part 52, effective filtering of vibrations within the actuator.

On the other hand, the fact that the set of batteries 33 is arranged, relative to the mechanical filtering member 50, opposite the actuator head 38, allows to maximize the mass and volume of the electronic board 142 and the elements it supports, which allows to reduce a cutoff frequency. Indeed, the mass of the battery impacts the mass of the complete electromechanical actuator 10 and thus influences the resonance frequency and the cutoff frequency.

The invention also presents an advantage in terms of cost price since a single part, with a geometry relatively simple to mold, fulfills a dual function of mechanical filtering and supporting the electronic board 142.

The invention also allows to reduce the number of steps during assembly of the electromechanical actuator 10 since the part 50, already equipped with the electronic board 142, can be installed in one operation within the casing 36.

According to one alternative, not represented, of the invention, the electronic board is received entirely in the volume V54 of the second part and does not extend into the internal volume V52 of the first part 52.

Any feature described above for one embodiment or alternative is applicable to the other embodiments and alternatives, provided that this is technically possible.

1. An electromechanical actuator of a concealment device, this actuator comprising at least one electric motor, a casing, an electronic control board and a mechanical vibrations-filtering member, the electric motor, the electronic control board and the filtering member being mounted inside the casing, in an assembled configuration of the electromechanical actuator,
characterized in that the mechanical filtering member comprises a first part forming a mechanical filter and a second part defining a volume for receiving the electronic board and in that the mechanical filtering member is monobloc.

2. The electromechanical actuator according to claim 1, wherein the first part of the mechanical filtering member is integral with a head of the electromechanical actuator and arranged, along a longitudinal axis of the mechanical filtering member, between the actuator head and the second part.

3. The electromechanical actuator according claim 2, wherein the first part of the mechanical filtering member is annular, whereas the second part of the mechanical filtering member is generally in the shape of a half-cylinder.

4. The electromechanical actuator according to claim 3, wherein an end of the first part of the mechanical filtering member and an end of the second part of the mechanical filtering member are common and form a ring.

5. The electromechanical actuator according to claim 1, wherein the first part is provided with slots and hinges arranged at the ends of the slots.

6. The electromechanical actuator according to claim 5, wherein the slots each extend according to a circumferential direction around a longitudinal axis of the mechanical filtering member.

7. The electromechanical actuator according to claim 6, wherein two slots and two hinges are provided in a same plane orthogonal to a longitudinal axis of the mechanical filtering member.

8. The electromechanical actuator according to claim 7, wherein the slots and hinges are provided in at least two planes orthogonal to a longitudinal axis of the mechanical filtering member and wherein the slots and hinges provided in a first plane orthogonal to the longitudinal axis are angularly offset, relative to the slots and hinges provided in a second plane orthogonal to the longitudinal axis.

9. The electromechanical actuator according to claim 8, wherein the slots and hinges provided in the first plane are angularly offset, by 90°, relative to the slots and hinges provided in the second plane.

10. The electromechanical actuator according to claim 1, wherein damping bushings are mounted around the mechanical filtering member and interposed between this member and an internal radial surface of the casing, at the two longitudinal ends of this member.

11. A motorized drive device for driving a screen of a concealment device, between at least a first position and at least a second position, comprising a winding tube of the screen and an actuator, according to claim 1, engaged in the winding tube and supported, relative to a supporting structure, by means of an actuator head engaged at least partially in the first part of the mechanical filtering member of the actuator.

12. A concealment device comprising:
a screen movable between at least one first position and at least one second position;
a motorized drive device for the screen between its first and second positions, which is according to claim 11.
